(19) United States
(12) Patent Application Publication
(10) Pub. No.: US 2020/0244772 A1
(43) Pub. Date: Jul. 30, 2020

(54) METHOD AND SYSTEM FOR CLOUD APPLICATION AND SERVICE INTEGRATION USING PATTERN-BASED DISCOVERY

(71) Applicant: HUAWEI TECHNOLOGIES CO., LTD., Shenzhen (CN)

(72) Inventors: Jin Rong Luo, Markham (CA); Chung-Man Abelard Chow, Markham (CA); Eissa Nematollahi Abdoljabbar, Richmond Hill (CA); Paul Chen, Markham (CA); Fu Gui, Markham (CA); Zhenhua Hu, Toronto (CA)

(21) Appl. No.: 16/262,140

(22) Filed: Jan. 30, 2019

(51) Int. Cl. H04L 29/08

(52) U.S. Cl. CPC H04L 67/34; H04L 67/2842; H04L 67/10

(57) ABSTRACT

A method of migrating an on-premises application that is developed for an on-premises environment to a cloud computing environment includes receiving, by a build server, application code of the on-premises application; and analyzing, by the build server, the application code of the on-premises application to identify a pattern in the on-premises application based on an application server service to be used by the on-premises software application in the cloud computing environment and an application platform service to be used by the on-premises application in the cloud computing environment. The application server service and the application platform service are part of a platform as a service (PaaS) layer of the cloud computing environment. The method includes generating, by the build server, data, based on the identified pattern, to configure the PaaS layer for migration of the on-premises application to the cloud computing environment.

### BACKGROUND

A cloud computing environment is a network-based computing environment (e.g., an Internet-based computing environment), which enables access to shared pools of configurable computing infrastructure and software services. These computing infrastructure and software services can be rapidly provisioned with minimal management effort, often over the Internet, to support (i.e., execute or run) software applications. Cloud computing is another paradigm shift that follows the shift from mainframe based computing to client-server based computing and is implemented as services. Cloud computing service providers (cloud providers) generally deliver three main types of services: infrastructure as a service (IaaS); platform as a service (PaaS); and software as a service (SaaS), by creating virtual machines on demand for use by customers. IaaS provides a computing infrastructure for creating virtual machines that can be rented and used by customers. The computing infrastructure includes physical computing resources (e.g. processors, memory, storage, servers, networking components, etc.) that are virtualized and shared among customers. PaaS provides platform services, such as application platform services, that allow customers to develop, run, and manage software applications without having to build and maintain the computing infrastructure. SaaS provides software applications that run on the computing infrastructure on demand over the Internet on a subscription basis.

The PaaS, generally includes two types of middleware software services: (1) application server services; and (2) application platform services. Application server services are used to run the software applications of the SaaS. The application server services manage the interaction between applications of the SaaS and the application platform services of the PaaS, enabling software applications of the SaaS to interact with the application platform services.

### SUMMARY

In a cloud computing environment, application platform services of the PaaS layer provide facilities, which software applications of the SaaS layer may use during execution of the software applications in the application server services of the PaaS layer. As examples of application platform services, an application that accesses a database may use a database platform service; an application that writes data to a file may use a file storage service; and so forth. As a result, software applications which are deployed in the SaaS layer, run on application server services of the PaaS layer, and integrate with (e.g., connect to and consume) application platform services of the PaaS layer.

A given software application (called an “on-premises application” herein) may be developed for a non-cloud based computing environment, such as an application that was developed before the era of cloud computing. One way to migrate an on-premises application to a cloud computing environment is to modify the application code (e.g., modify the machine executable instructions of the application). For example, the application code of the on-premises application may be modified to incorporate cloud computing environment variables into the application code, such that when the modified on-premises application is migrated to the cloud computing environment, the environment cloud computing variables are exposed to enable the modified on-premises application to be deployed in the SaaS layer of the cloud computing environment, run on a particular application server service of the PaaS layer of the cloud computing environment, and integrate with (e.g., connect to and consume) a particular application platform service of the PaaS layer. Alternatively, a cloud adapter may be incorporated directly into the on-premises application to enable the on-premises application to be migrated to a cloud computing environment (e.g., by deploying the on-premises application with the integrated cloud adapter in the SaaS layer, run on an application server service of the PaaS layer, and integrate with (e.g., connect to and consume) an application platform service of the PaaS layer.

In accordance with example implementations that are disclosed herein, the PaaS layer of the cloud computing environment is modified, in lieu of modifying the application code of the on-premises application. In this manner, as further described herein, the application code on-premises application may be analyzed for purposes of identifying a particular integration pattern based on an application server service to be used by the application (after migration) and an application platform service to be used by the application (after migration) in the cloud environment. Based on the identified integration pattern, a customization procedure is identified to generate a customized server service for the PaaS layer that enables the on-premises application to run on the customized server service and integrated with the application platform service without any modification to the application code of the on-premises, thereby resulting in a “lift and shift” migration of the on-premises application to the cloud computing environment.

According to an aspect of the present disclosure, there is provided a method of migrating an on-premises application that is developed for an on-premises environment to a cloud computing environment. The method includes receiving, by a build server, application code of the on-premises application; and analyzing, by the build server, the application code of the on-premises application to identify a pattern in the on-premises application based on an application server service to be used by the on-premises software application in the cloud computing environment and an application platform service to be used by the on-premises application in the cloud computing environment. The application server service and the application platform service are part of a platform as a service (PaaS) layer of the cloud computing environment. The method includes generating, by the build server, data, based on the identified pattern, to configure the PaaS layer for migration of the on-premises application to the cloud computing environment.

According to another aspect of the present disclosure, there is provided a non-transitory machine readable storage medium to store instructions that, when executed by a machine, cause the machine to analyze application code of an application based on a cloud-based application server category and a cloud-based application platform service category to recognize a pattern of the application code. The instructions, when executed by the machine, cause the machine to, based on the recognized pattern, determine a configuration for a cloud-based application server service of a cloud-based computer system to prepare the cloud-based computer system for migration of the application to the cloud-based computer system.

According to another aspect of the present disclosure, there is provided an apparatus that includes at least one processor and a memory. The memory stores instructions that, when executed by the processor(s), cause the processor(s) to access a file that is associated with at least one of installing an application server service of a cloud computer system or configuring the application server service; and analyze application code of an application to be migrated to the cloud computer system to identify a pattern that is associated with the application based on an application platform service to be used by the application after being migrated to the cloud computer system. The instructions, when executed by the processor(s), cause the processor(s) to communicate with a repository to receive data representing a procedure to be performed based on the identified pattern; and modify the file based on the procedure to prepare the cloud computer system for migration of the application to the cloud computer system.

In any of the preceding aspects, analyzing the application code to identify the pattern includes performing analysis of application code of the application.

In any of the preceding aspects, analyzing the application code to identify the pattern includes searching for a file name in the application code or text in the application code.

In any of the preceding aspects, identifying the pattern includes identifying a plurality of candidate patterns that are associated with the application based on the application server service and the application platform service; and selecting a given pattern of the plurality of candidate patterns based on a predetermined selection criterion.

In any of the preceding aspects, generating the data includes at least one of generating data to configure a configuration file that is associated with the application server service, generating data to configure a library that is associated with the application server service, or generating data to configure a network proxy that is associated with the application server service.

In any of the preceding aspects, generating the data includes communicating with a repository to receive data identifying a procedure that is associated with the identified pattern, and generating the data to configure the PaaS layer for the migration of the application based on the procedure.

In of the preceding aspects, generating the data includes generating data to modify at least one of a configuration file or an installation file that is associated with an application server service of the PaaS layer.

In any of the preceding aspects, the application platform service includes a caching service, a database platform service, or a file service.

In any of the preceding aspects, the application is migrated to a cloud computer system without modifying application code that is associated with the application.

### BRIEF DESCRIPTION OF THE DRAWINGS

FIG. 1 is a block diagram illustrating a cloud computing environment for delivering cloud computing services according to an example implementation.

FIG. 2 is an illustration of the integration of an on-premises software application into a cloud computing environment according to an example implementation.

FIG. 3 is a schematic diagram illustrating an architecture to integrate an on-premises application into a cloud computer environment according to an example implementation.

FIG. 4 is a flow diagram depicting a method to generate a customized application server service for integration of an on-premises application into a cloud computing environment according to an example implementation.

FIG. 5 is an illustration of the structures and relationships of a services catalog, a customization procedures repository, a server artifacts repository and an integration patterns repository of FIG. 4 according to an example implementation.

FIG. 6 is a flow diagram depicting a method to discover integration patterns through application code analysis according to an example implementation.

FIG. 7 is an illustration of an integration pattern-based modification of a configuration file associated with an application server service according to an example implementation.

FIG. 8 is an illustration of an integration pattern-based modification of a library associated with an application server service according to an example implementation.

FIG. 9 is an illustration of an integration pattern-based modification of a network proxy associated with an application server service according to an example implementation.

### DETAILED DESCRIPTION

In this era of cloud computing, a lot of companies are trying to migrate their software applications from an on-premises environment to a cloud computing environment. In this context, a “cloud computing environment” refers to a remotely accessed computer system of hardware and software, which provides rented cloud-related services to a company, such as software as a service (SaaS), platform as a service (PaaS) and infrastructure as a service (IaaS); and an “on-premises computing environment” refers to a computer system of hardware and software, which may be owned and maintained by a company. A primary motivation to migrate software applications developed for deployment on on-premises computing environment (e.g., on-premises applications) to the cloud computing environment is the reduction of the total costs associated with owning and maintaining computing infrastructure and software applications, while enjoying high-availability, scalability and reliability benefits that are provided by cloud providers providing cloud computing environments.

Migrating an on-premises application to the cloud computing environment may involve cloud application and cloud service integration (referred to hereinafter as cloud integration). Cloud integration enables on-premises applications developed for deployment in an on-premises environment to be deployed in the SaaS layer of the cloud computing environment, to run on an application server service of the PaaS layer of the cloud computing environment, and to integrate with (e.g. connect to and consume) an application platform service of the PaaS layer of the cloud computing environment. An on-premises application that is developed and deployed in an on-premises computing environment has no knowledge about the cloud computing environment and the application platform services of the cloud computing environment. The cloud integration of the on-premises application with the cloud computing environment, in general, involves changes that ensure that the on-premises application, can be deployed in the SaaS layer of the cloud environment, run on an application server service of the PaaS layer of the cloud environment, and connects to and consumes the application platform service of the PaaS layer in the same way that the on-premises application runs on an application server and connects with application platforms of the on-premises computing environment.

One way to migrate an on-premises application into a cloud computing environment is to modify the application code (e.g., modify the machine executable instructions of the on-premises application). For example, the application code may be modified to incorporate environment variables. Environment variables refer to a set of named values defined in the cloud computing environment, and the environment variables are exposed and used by the modified on-premises application after migration of the modified on-premises application to the cloud computing environment. This is a way of communicating the environment settings, service configurations and connection information to the on-premises application after migration to of the cloud environment. For application server service integration, the on-premises application, after being migrated to the cloud computing environment (e.g. deployed in the SaaS layer), uses the corresponding service environment variables to connect and consume an application platform service.

Another way to migrate an on-premises application to a cloud computing environment is through the use of a cloud adapter. A cloud adapter is special purpose software, which connects on-premises applications to different application platform services of the PaaS layer of the cloud computing environment. Developers may adopt the cloud adapter directly in the on-premises application, or the cloud adapter may be included with the on-premises application.

Modifying an on-premises application, such as through the above-described environment variables or cloud adapter, may involve significant costs and time. In this manner, such modifications may involve substantial redesign or rewriting of the application code of the on-premises application, which may be costly or, in general, may not be feasible. In accordance with example implementations that are described herein, a customized application server service is generated for a cloud computing that enables integration of the on-premises application into a cloud computing environment, without any modifications to the application code of the on-premises application.

More specifically, in accordance with example implementations, the on-premises application may be associated with a particular application server service category, or type. For example, the on-premises application may be a Java application that uses a Tomcat server in the on-premises computing environment; and when migrated to the cloud computing environment, the on-premises application correspondingly uses a Tomcat application server service. The on-premises application may also, after being migrated to the cloud computing environment, use one or multiple application platform services, such as a caching service, a database platform service, a file service, and so forth.

As described herein, methods to migrate an on-premises application to the cloud computing environment (so that the application is integrated with the cloud computing environment) include deploying the on-premises application in the SaaS layer of the cloud computing environment (e.g., copying the application code to an SaaS layer of the cloud computing environment without any changes to the application code of the on-premises application); selecting the appropriate application server service; selecting the appropriate application platform service(s); and generating a customized application server service so that the on-premises application, when deployed in the SaaS layer, runs on the customized application server service, and integrates with the application platform service(s).

More specifically, in accordance with example implementations, a build server may use the following method to migrate an on-premises application into a cloud computing environment. The build server receives information including user selected data representing aspects of the integration, such as the application code; a user-selected application server service category, or type; and one or multiple user selected application platform service categories, or types, to be used by the application. Based on the received information, the build server retrieves application server service artifacts from a server service artifacts repository. In this context, the “server artifacts” refer to information pertaining to the configuration of the application server service, such as, for example, installation and/or configuration files for the application server service. In accordance with some implementations, the server artifacts repository stores server artifacts for all application server services (a Tomcat server service, an Apache server service, a Node.js server service, as examples).

In accordance with example implementations, the build server discovers an integration pattern associated with the on-premises application (through the use of integration pattern-based matching, as described herein) for purposes of identifying a suitable procedure for modifying the application server service. In accordance with example implementations, the build server may discover an integration pattern associated with the on-premises application by analyzing the application code to identify or discover integration patterns associated with the on-premises application, which match patterns that are stored in an integration patterns repository. As further described herein, a given integration pattern may be associated with one or more of the following: machine executable instructions of the application; settings of the on-premises application, texts of the on-premises application, procedures or file names associated with the on-premises application; settings contained in the server service artifacts; machine executable instructions appearing in the server artifacts; file names or procedures identified in the server artifacts; and so forth.

More specifically, in accordance with example implementations, the build server may perform the integration pattern discovery by analyzing the application code of the on-premises application and application server artifacts for purposes of determining whether the application code of the on-premises application and/or the application server artifacts exhibit integration patterns that correspond to one or multiple integration patterns that are stored in the integration patterns repository. For the case in which the build server discovers multiple such integration patterns, then, as further described herein, the build server may select one of these integration patterns based on an integration pattern preference, which may be defined by the cloud service provider.

A selected integration pattern, in turn, corresponds to a particular customization procedure, which the build server retrieves from a customization procedures repository. In accordance with example implementations, the customization procedure defines how the build server is to modify the application server service to integrate the on-premises application into the cloud computing environment. In general, the customization procedures repository may store the customization procedures available for all integration patterns. The build server may then, based on the retrieved customization procedure, modify the application server artifacts to generate a customized application server service to enable the on-premises application to migrate to the cloud computing environment. As described further herein, the customization procedures for generating the customized application server service may involve, as examples, modifying a configuration file associated with the application server services, modifying a library associated with the application server services, or modifying a network proxy associated with the application server services.

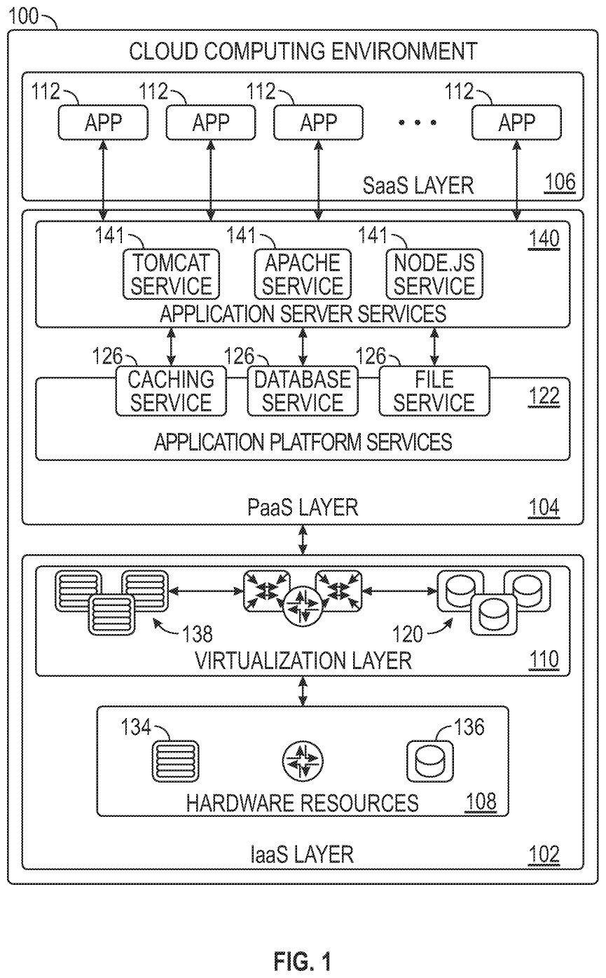

Referring to FIG. 1, as a more specific example, in accordance with some implementations, a cloud computing environment 100 for delivery computing services is shown. The cloud computing environment 100 includes an IaaS layer 102, a PaaS layer 104; and SaaS layer 106.

The PaaS layer 104 provides the capabilities for hosting and running the applications 112 of the SaaS layer 102 and includes the following middleware layers: application server services 140 and application platform services 122. For the example implementation that is depicted in FIG. 1, the application server services 140 include such specific application server services as a Tomcat server service 141, an Apache server service 141 and a Node.js server service 141 that host and run the applications 112. The application server services 140, in general, manage the integration of the applications 112 with the application platform services 122. The application platform services 122 provide a set of application platform services to the applications 112 that are hosted and run on the application server services 140.

The applications 112 may be potentially associated with many different application server types, or categories. For example, a particular application 112 may be a Java application that is associated with the Tomcat server service 141; another application 112 may be a PHP application that is associated with the Apache server service 141; another application 112 may be a JavaScript application that is associated with the Node.js server service 141; and so forth. For the example implementation that is depicted in FIG. 1, the application platform services 122 include a caching platform service 126, a database platform service 126 and a file platform service 126.

The IaaS layer 102 may include, as an example, a hypervisor, or virtualization layer 110, which may provide virtual machines 138, virtual storage 120, and so forth. The virtualization layer 110 generates virtual machines using actual, physical hardware resources 108 of the IaaS layer 102, such as actual, physical processor-based computing machines 134, physical storage devices 136, and so forth.

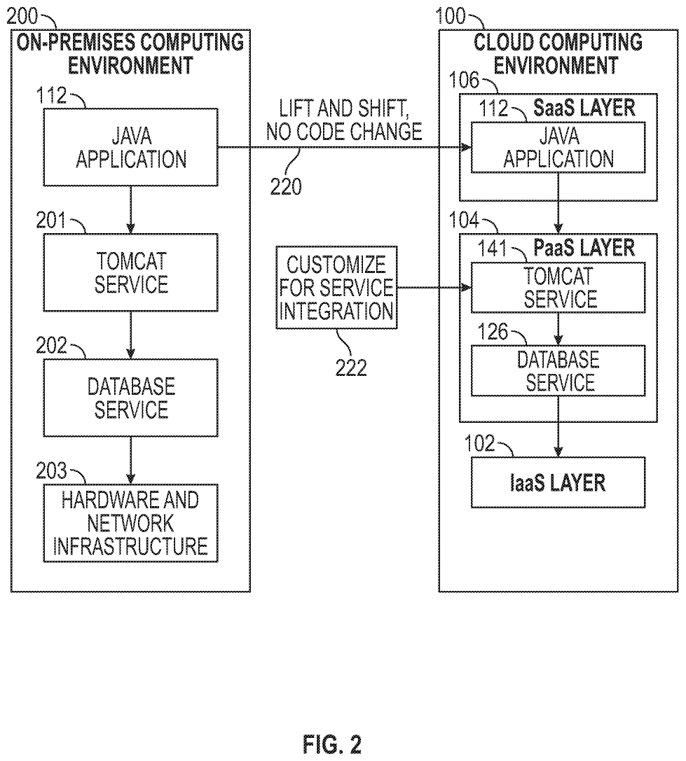

FIG. 2 illustrates the integration of an on-premises Java application 112 (which was originally designed to execute on an on-premises computing environment 200) into the cloud computer environment 100, in accordance with an example implementation. For this example, the on-premises computer system 200 includes, a Tomcat server service 201 that executes the application code of the on-premises Java application 112, and due to the execution of the application code, the Tomcat server service 201 may access a database server service 202, as well as hardware and network infrastructure 203 of the on-premises computing environment 200.

In accordance with example implementations, migration of the on-premises Java application 112 into the cloud computer environment 100 involves a “lift-and-shift” 220 of the on-premises application 112 (e.g., copying of the application code, configuration files, libraries, and so forth) of the on-premises application 112 into the SaaS layer 106 of the cloud computer environment 100 without any modifying of the application code of the on-premises software application. As depicted in FIG. 2, in the cloud computer environment 100, the Java application 112-1 is hosted and run on a customized Tomcat server service 141, which is customized (as depicted at reference numeral 222) based on identified integration patterns (as further described herein) for purposes of satisfying the requirements for the cloud application and service integration, so that the Java application 112 may integrate with (e.g., connect to and consume) the database platform service 126.

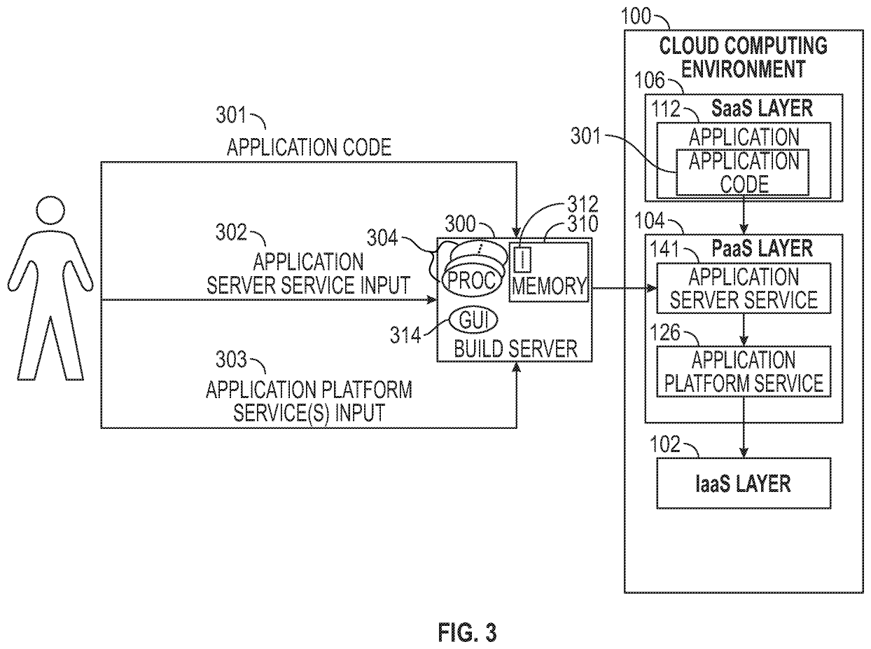

FIG. 3 illustrates the use of a build server 300, for purposes of modifying the on-premises application server service 141 to generate a customized application server service 141 for the PaaS layer 104 of the cloud computer environment 100, in accordance with example implementations. In accordance with example implementations, the build server 300 is an actual, physical machine that is made up of actual software and actual hardware. In this manner, in accordance with some implementations, the build server 300 may include one or multiple processors 304 (e.g., one or multiple central processing units (CPUs), CPU processing cores, and so forth). Moreover, the processor(s) 304 may execute machine executable instructions 312 that are stored in a memory 310 of the build server 300. In accordance with example implementations, the memory 310 is a non-transitory memory that may be formed from semiconductor storage devices, magnetic storage devices, non-volatile memory devices, phase change storage devices, volatile memory devices, a combination of storage devices associated with any combination of the foregoing storage technologies, and so forth.

As described herein, one or multiple processors 304 may execute the instructions 312 for purposes of performing one or more of the methods that are described herein, such as, for example, analyzing the application code to identify integration patterns in application code of the software application; modifying an application server service for purposes of migrating an on-premises software application to a cloud computing environment; and so forth. Moreover, as depicted in FIG. 3, one or multiple processors 304 may execute machine executable instructions 312 for purposes of forming one or more components of the build server 300, such as an operating system, a graphical user interface (GUI) 314, device drivers, and so forth.

Although FIG. 3 depicts a single build server 300, the build server 300 may include multiple computers deployed on single or multiple racks. In accordance with some implementations, the build server 300 may be one or multiple virtual machines provided by IaaS layer of the cloud computing environment 100.

In accordance with example implementations, regardless of its particular form, the build server 300 receives the on-premises application to be migrated to the cloud computer environment 100, a user input describing the application server service to be used to host and run the on-premises application, and a user input describing the application platform service(s) to be used by the on-premises application after migration. As further described herein, one or multiple of the user inputs may be provided through user interaction with the GUI 314. The build server 300 generates data, which is used to generate a customized application server service 141. As an example, the build server 300 receives the application code 301, including the source code for the on-premises application, configuration files for the software application, and libraries for the on-premises application for the on-premises application. As depicted in FIG. 3, the user inputs to the build server 300 include application server service input 302 that represents an application server service type, i.e., the type of application server service to host and run the on-premises application 112 after migration to the cloud computer environment 100; and application platform service(s) input 303 that represents one or multiple application platform service types, that are to be integrated with the on-premises application 112.

In accordance with example implementations, after receiving the above-described input, the build server 300 uses an automated process (i.e., a computer-directed process that the build server 300 performs automatically without further user input) to generate data (data customizing a configuration file of the application server service 141, data customizing a library of the application server service 141, data setting up a network proxy for the application server service 141, and so forth) for purposes of customizing the application server service 141 so that the application code 301 may be copied to the SaaS layer 106 without modification to integrate the on-premises application into the cloud computing system 100.

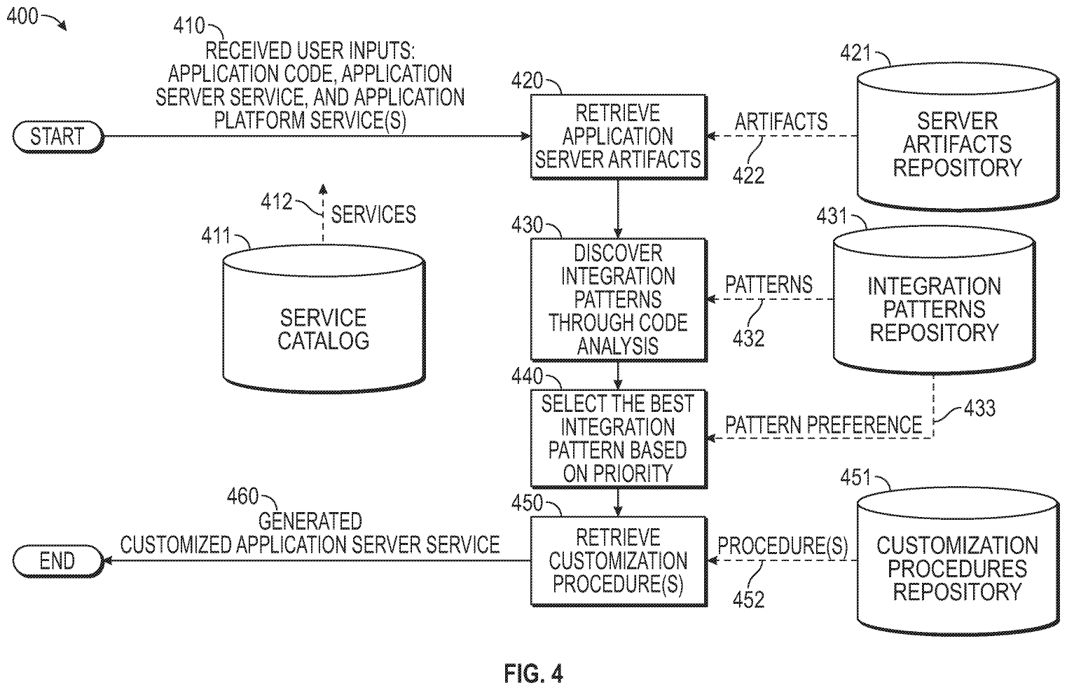

FIG. 4 illustrates a flow diagram 400 depicting a process used by the build server 300 to migrate an on-premises software application to a cloud computing environment, in accordance with example implementations. The method 400 includes, pursuant to block 410, the build server 300 receiving (block 410) inputs, including the application source code of the on-premises application to be migrate to the cloud computing environment 100; the application server service type; and the application platform service type(s). In accordance with example implementations, as depicted in FIG. 4, a service catalog 411 includes a list of the available application server services 141 and application platform services 126 available in the PaaS layer of the cloud computing environment 100. Users may look up the services catalog 411 and the build server 300 receives a selection of the type of application server service and the type of application platform service that the software application requires for migration to the cloud computer environment 100. As described further herein, the specific services 412 included the services catalog 411 correspond to the names and locations of details used in the customization of the application server service.

As depicted at block 420, based on the selected type of application server service, the build server 300 retrieves application server service artifacts 422 from a server artifacts repository 421 corresponding to the type of selected application server service. In accordance with example implementations, the application server service artifacts, in this context, refer to configurations files, installation files that are associated with the selected type of application server service and which are used to generate a customized application server service. As a more specific example, in accordance with some implementations, the application server service artifacts may be installation files (i.e., files to install the application server service) and/or configuration files (i.e., files to configure the application server service). In accordance with example implementations, the server artifacts repository 421 stores artifacts for all supported application server service types.

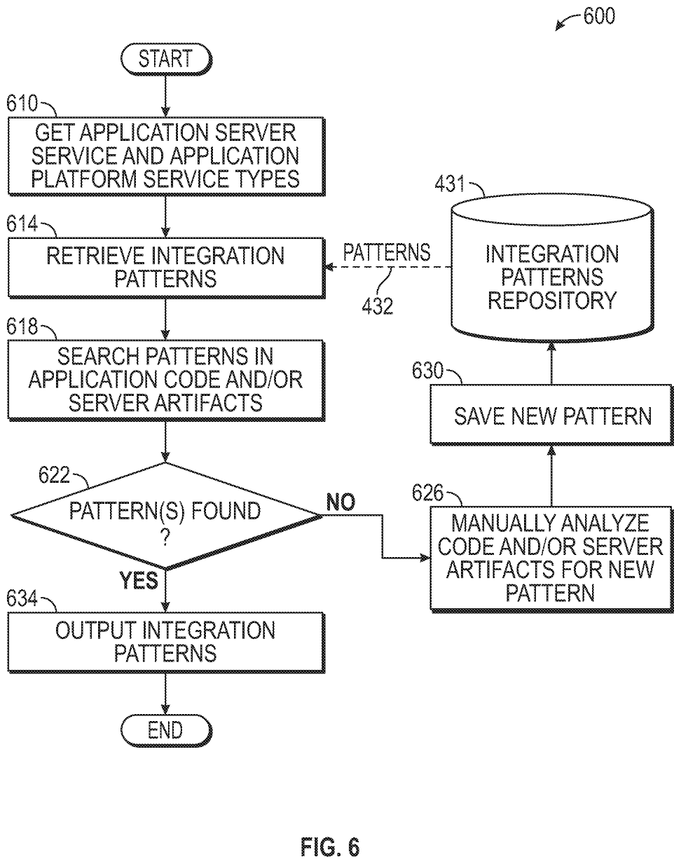

As depicted at block 430, based on the selected application server service type and the selected application platform service type, the build server 300 discovers one or multiple integration patterns through code analysis of the application code of the software application 112 and/or the server service artifacts. In this context, an “integration pattern” refers to a particular sequence of code, filenames, calls, configurations, and so forth, associated with the application code and/or server artifacts. The integration pattern has an associated customization procedure for the application server service. Therefore, by discovering a particular integration pattern, as further described herein, the build server 300 discovers a specific way to modify, or customize, the application server service. As described in more detail in connection with FIG. 6, the build server 300 uses a knowledge base of integration patterns 432 stored in an integration patterns repository 431 to discover integration patterns in block 430.

In accordance with example implementations, the build server 300 may analyze the application code to identify one or multiple integration patterns in block 430. If multiple integration patterns are identified in the application code, then, in accordance with example implementations, the build server 300 may select the most suitable pattern based on a pattern preference 433, which may be stored in the integration patterns repository 431. In accordance with example implementations, the pattern preference 433 represents one or multiple criteria to be used by the build server 300 to select the best integration pattern (according to the criteria) from multiple discovered integration patterns. As a more specific example, in accordance with some implementations, the integration patterns may be assigned priorities for different performance metric criteria categories; the integration pattern preference 433 may, for example, identify which performance metric category controls selection of the integration pattern; and the build server 300 may select the highest priority integration pattern (from the discovered integration patterns) from the performance metric category that is identified by the pattern preference 433.

In accordance with example implementations, the cloud computing service provider defines the preferences of integration patterns according to integration needs. For example, if application connection time to a particular application platform service is important, then the integration pattern preference 433 may identify that connection time controls selection of the integration pattern. Accordingly, for this example, a first integration pattern that is associated with modifying a configuration file associated with the application server service may be may be preferred over a second integration pattern that is associated with creating a network proxy, as the network proxy may add network latency to the service integration. The first integration pattern may correspondingly have a higher priority for connection time than the priority of the second integration pattern. It is noted that the cloud provider may change the integration pattern preferences 433 over time.

Upon selecting the integration pattern, the build server 300 retrieves (block 450) a set of one or multiple customization procedures 452 to be performed to modify the application server service to generate a customized application server service. In general, customization procedures may be stored in a customization procedure repository 451. A customization procedure is a set of instructions (machine executable instructions, for example), which may be executed by the build server 300 to customize the application server service artifacts for purposes of generating a customized application server service. In general, the customization procedure repository 451 stores these customization procedures for all integration patterns. As also depicted in block 460 of FIG. 4, the build server 300 uses the retrieved customization procedure(s) 452 to modify the application server service artifacts, i.e., modify one or multiple configuration files and/or installation files of the application server service.

FIG. 6 depicts a flow diagram 600 illustrating the pattern discovery process 430 of FIG. 4, in accordance with example implementations. Referring to FIG. 6, pursuant to the method 600, the build server 300 first obtains (block 610) the application server service type and the application platform service type and retrieves (block 610) the applicable integration patterns 432 from the integration patterns repository 431. The build server 300 next performs an analysis of the application code of the software application (i.e., a code analysis using pattern matching) for purposes of determining whether integrated patterns exist in the on-premises software application 112-1. In accordance with example implementations, this code analysis may involve searching the application code to discover particular patterns or sequences involving the following or combinations thereof, functions, methods, files, text, settings, variable names, and so forth. In accordance with some example implementations, the searching for integration patterns may include searching the server artifacts (i.e., the configuration and/or installation files of the application server service) to discover particular patterns or sequences involving the following or combinations thereof: functions, methods, files, text, settings, variable names, and so forth. Moreover, in accordance with some example implementations, searching for integration patterns may involve searching for a particular pattern that appears in both a server artifact and the application code (e.g., a pattern represented by certain settings in a configuration file and the application code).

Therefore, by searching (block 610) for integration patterns, the build server determines (decision block 622) whether an integration pattern has been found. If no existing integration patterns are identified for the software application 112, then, as depicted at block 626, a human analyst may manually analyze the application code and/or server artifacts to identify any previously-undiscovered or undocumented integration pattern. This new pattern may then be saved (block 630) in the integration patterns repository 431 so that next time, a similar application may use the saved integration pattern. Otherwise, if one or multiple integration patterns are found (decision block 622), then the build server 300 outputs (block 634) the discovered integration pattern(s).

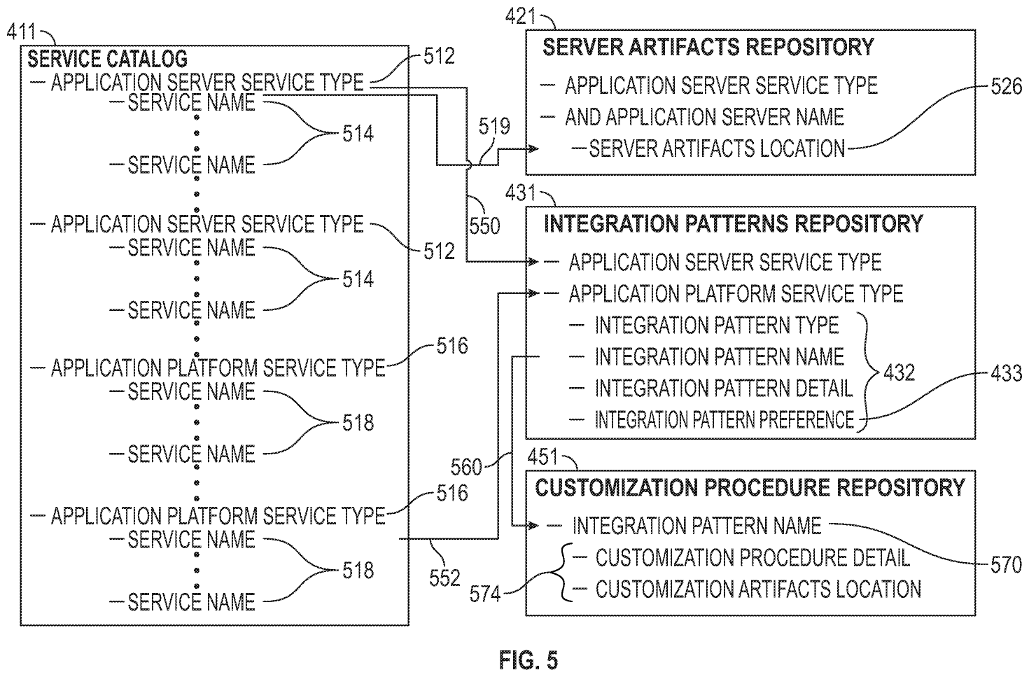

FIG. 5 illustrates structures of the repositories 421, 431, and 451 and their relationships to the service catalog 411, in accordance with example implementations. In general, the service catalog 411 lists the available application server services and application platform services available in the cloud computing environment 100. In accordance with example implementations, the service catalog 411 is viewable through the GUI 314 (FIG. 3), and users may look up the service catalog 411 to select the application server type and application platform services service type.

As depicted in FIG. 5, in accordance with example implementations, the service catalog 411 includes application server service type identifiers 512 and application platform service identifiers 516. As examples, the application server service type identifiers 512 may identify Tomcat 8, Apache 2.4 and Node.js 8 as available application server service types. Each application server service identifier 512 may be associated with one or multiple specific application server service name identifier 514. As examples, Java Tomcat Service 8, PHP Apache Service 2.4, and JavaScript Node.js Service 8 may be specific services for the Tomcat 8, Apache 2.4 and Node.js 8 application server service types, respectively.

As examples, the application platform service type identifiers 516 may identify a database platform service and a file service as available application platform service types. Each application platform service identifier 516 may be associated with one or multiple specific application platform service name identifier 518. As examples, MySQL Database platform service and File Storage Service may be specific services for the database platform service and file service application platform service types, respectively.

User selection of a specific application server service name identifier 514 provides an index 519 that the build server 300 may use to access the artifacts 422 for the selected application server service. In this manner, as depicted in FIG. 5, the index 519 directly or indirectly points to a specific location 526 in the server artifacts repository 421 from which the build server 300 may retrieve the artifacts 422. User selection of a specific application server service name identifier 514 and specific application platform service name identifier 518 provide an index 550 that the build server 300 may use to directly or indirectly access one or multiple integration patterns 432, which the build server 300 may use for pattern matching-based discovery discussed herein. The information that the build server 300 retrieves from the integration pattern repository 431 may include, for each pattern 432, a pattern type, a pattern name, pattern details, a pattern preference 433, a priories associated with the patterns, and so forth.

Each integration pattern name may provide an index 560 that directly or indirectly points to information 570 that is stored in the customization procedures repository 451. By using the index 560, the build server 300 may, for example, retrieve data 574 representing the customization procedures 452 (such as details 570 (machine executable instructions or a flow, for example) for customizing the application server services) and artifacts (e.g., files, libraries and so forth) pertaining to the configurations of the application server services.

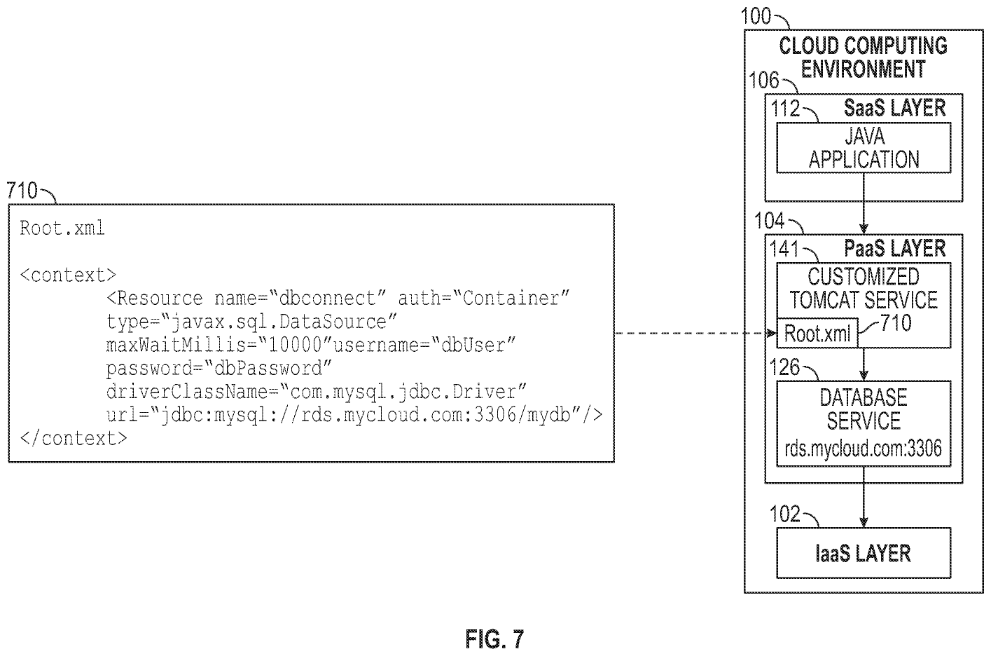

FIG. 7 is an illustration of the modification of a configuration file of the application server service 141, in accordance with example implementations. In configuring the configuration file, cloud integration may be performed relying on a discovered integration pattern that is formed from certain settings that appear in the application code and/or inside the application server service (certain settings inside a configuration file of the application server service, for example). Examples of such settings are a platform service location, a connection username, and a password. In this manner, the build server 300 may, for example, identify a particular integration pattern based on such settings and modify a configuration file based on discovering these settings.

In the example that is depicted in FIG. 7, the integration pattern is the discovered context setting in a Root.xml file inside the Tomcat server service. The modification of the Root.xml file is depicted at reference numeral 710 of FIG. 7, and, as shown, the build server 300 modifies the Root.xml file of the Tomcat server service to direct access by the Java application 112 when the Java application 112 uses the URL mysql://rds.mycloud.com:3306/mydb.

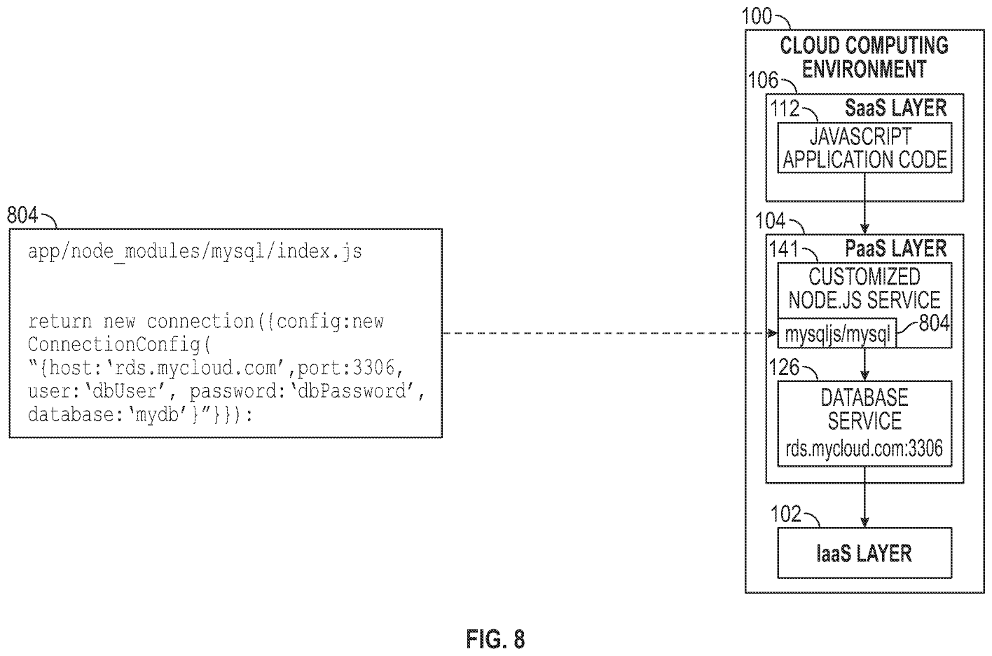

FIG. 8 is an illustration of the modification of a library of the application server service to generate a customized application server service according to an example implementation. For this example, the application 112 is a JavaScript application that has an associated Node.js server service 141, and the application 112 is to access a database platform service 126. FIG. 8 illustrates the discovery of a library integration pattern by the build server 300, i.e., the discovery of a certain library or libraries inside the application code of the application 112 or application server service. These libraries contain integration information used to connect to the application platform service. The build server 300 discovers this integration information through the integration pattern matching and configures the corresponding information to connect the application 112 to the application platform service such that the application 112 consumes the application platform service when executed.

For the example that is depicted in FIG. 8, the build server 300 performs the integration by modifying the Node.js service's Mysqli library. The Mysqli library contains code called, “ConnectionConfig,” which contains the integration information. After the build server 300 modifies this information, the Tomcat service 141 may connect to the database platform service 126, and integration is achieved.

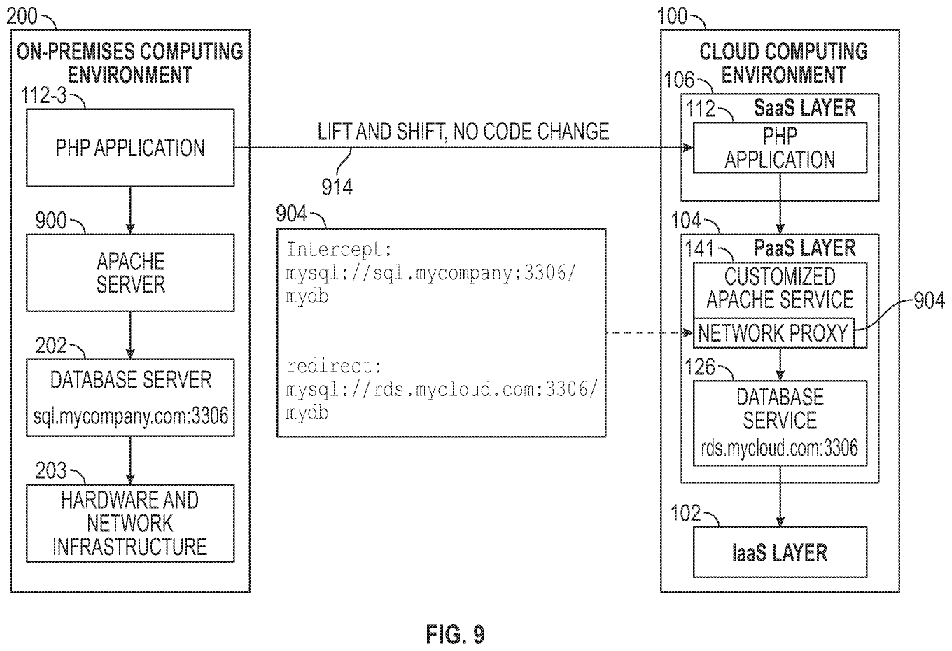

FIG. 9 depicts another example in which a PHP application 112 is migrated to the cloud computer environment 100 by invoking cloud integration. The PHP application 112 executes on an Apache server service 141 and accesses a database platform service 126. This example illustrates the discovery of a network-associated integration pattern, i.e., a pattern associated with the network connections between the application server service 141 and the database platform service 126. A network proxy is software that can intercept and redirect network connections. The build server 300, for this example, adds a network proxy 904 to the Apache server service 141 for purposes of modifying the network activities so that after integration is performed, a network proxy is created to redirect communications from the PHP application 112 to the database platform service 126.

In the example that is depicted in FIG. 9, before invoking cloud integration, the PHP application 112 was integrated with the database platform service (address is sql.mycompany.com:3306) of the on-premises computer environment. After migration of the PHP application 112 to the cloud computing environment, the on-premises environment's database server and database server address are no longer available. In the cloud computing environment, the compatible database platform service is available and the database platform service address is rds.mycloud.com:3306. Because the PHP application 112 did not change, the application 112 is still trying to connect to on-premises environment's database server, which results in network connection failure. The network proxy 904 may capture the network connection failure and redirect it to the cloud computing environment's database platform service 126. As a result, the PHP application 112 may, through this redirection, connect to the database platform service 126.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method of migrating an on-premises application developed for an on-premises environment to a cloud computing environment, the method comprising:
receiving, by a build server, application code of the on-premises application;
analyzing, by the build server, the application code of the on-premises application to identify a pattern in the on-premises application based on an application server service to be used by the on-premises software application in the cloud computing environment and an application platform service to be used by the on-premises application in the cloud computing environment, wherein the application server service and the application platform service are part of a platform as a service (PaaS) layer of the cloud computing environment; and
generating, by the build server, data, based on the identified pattern, to configure the PaaS layer for migration of the on-premises application to the cloud computing environment.

2. The method of claim 1, wherein analyzing the application code to identify the pattern comprises performing analysis of application code of the application.

3. The method of claim 2, wherein performing analysis of the application code comprises searching for a file name in the application code or text in the application code.

4. The method of claim 1, wherein analyzing the application code to identify the pattern comprises:
identifying a plurality of candidate patterns associated with the application based on the application server service and the application platform service; and
selecting a given candidate pattern of the plurality of candidate patterns based on a predetermined selection criterion.

5. The method of claim 1, further comprising:
migrating the application to the cloud computing environment without modifying the application code of the on-premises application.

6. The method of claim 1, further comprising:
identifying multiple candidate patterns based on the application server service and the application platform service; and
based on an integration pattern preference, selecting one of the candidate patterns and configuring the PaaS layer based on the selected candidate pattern.

7. The method of claim 1, wherein generating the data comprises at least one of generating data to configure a configuration file associated with the application server service, generating data to configure a library associated with the application server service, or generating data to configure a network proxy associated with the application server service.

8. The method of claim 1, wherein generating the data comprises communicating with a repository to retrieve data identifying a procedure associated with the identified pattern, and generating the data to configure the PaaS layer for the migration of the application based on the procedure.

9. The method of claim 1, wherein generating the data comprises generating data to modify at least one of a configuration file or an installation file associated with an application server service of the PaaS layer.

10. The method of claim 1, wherein the application platform service comprises a caching platform service, a database platform service, or a file platform service.

11. A non-transitory machine readable storage medium that stores instructions that, when executed by a machine, cause the machine to:
analyze application code of an application based on a cloud-based application server service category and a cloud-based application platform service category to recognize a pattern of the application code; and
based on the recognized pattern, determine a configuration for a cloud-based application server service of a cloud-based computer system to prepare the cloud-based computer system for migration of the application to the cloud-based computer system.

12. The non-transitory machine readable storage medium of claim 11, wherein the instructions, when executed by the machine, further cause the machine to:
modify a configuration file or an installation file associated with the application server service based on the determined modification.

13. The non-transitory machine readable storage medium of claim 11, wherein the instructions, when executed by the machine, further cause the machine to:
communicate with a repository to receive a set of repository patterns based on the cloud-based application server category and the cloud-based application platform service; and
determine whether the application code contains any of the patterns of the repository patterns.

14. The non-transitory machine readable storage medium of claim 11, wherein the instructions, when executed by the machine, further cause the machine to:
identify multiple candidate patterns based on the cloud-based application server category and the cloud-based application platform service; and
based on an integration pattern preference, select one of the candidate patterns and determine the configuration for the application server service based on the selected candidate pattern.

15. The non-transitory machine readable storage medium of claim 11, wherein the instructions, when executed by the machine, further cause the machine to determine a configuration for at least one of a configuration file, a library or a network proxy associated with the application server service.

16. An apparatus comprising:
at least one processor; and
a memory to store instructions that, when executed by the at least one processor, cause the at least one processor to:
access a file associated with at least one of installing an application server service of a cloud computer system or configuring the application server service;
analyze application code associated with an application to be migrated to the cloud computer system to identify a pattern associated with the application based on an application server service and an application platform service to be used by the application after being migrated to the cloud computer system;
communicate with a repository to receive data representing a procedure to be performed based on the identified pattern; and
modify the file based on the procedure to prepare the cloud computer system for migration of the application to the cloud computer system.

17. The apparatus of claim 16, wherein the instructions, when executed by the at least one processor, further cause the at least one processor to migrate the application to the cloud computer system without modifying the application code associated with the application.

18. The apparatus of claim 16, wherein the application platform service comprises at least one of a caching service, a database platform service or a file service.

19. The apparatus of claim 16, wherein the application server service and the application platform service are associated with a Platform as a Service (PaaS) layer of the cloud computer system, and the application, after migration, is associated with a Software as a Service (SaaS) layer of the cloud computer system.

20. The apparatus of claim 16, wherein the instructions, when executed by the at least one processor, further cause the at least one processor to search for specific text or file names in application code of the application based on the application server service and the application platform service to identify the pattern.
